(19) United States
(12) Patent Application Publication
(10) Pub. No.: US 2013/0151209 A1
(43) Pub. Date: Jun. 13, 2013

(54) METHOD FOR DESIGNING UNIFORM ILLUMINATION REFLECTOR

(71) Applicants: Weiqi Liu, Guangdong (CN); Gang Yang, Guangdong (CN); Baoyu Jin, Guangdong (CN); Xueyu Rong, Guangdong (CN); Deyuan Wei, Guangdong (CN)

(72) Inventors: Weiqi Liu, Guangdong (CN); Gang Yang, Guangdong (CN); Baoyu Jin, Guangdong (CN); Xueyu Rong, Guangdong (CN); Deyuan Wei, Guangdong (CN)

(21) Appl. No.: 13/818,713

(22) PCT Filed: Aug. 30, 2011
(86) PCT No.: PCT/CN2011/079081

§ 371 Date: Feb. 25, 2013

(30) Foreign Application Priority Data
Aug. 30, 2010 (CN) 201010266973.1

(51) Int. Cl. G06F 17/50

(52) U.S. Cl. CPC G06F 17/50
USPC 703/1

(57) ABSTRACT

A method for designing uniform illumination reflector, which has a light entering opening and a light emitting opening, includes the steps of: determining a light source, the diameter of an illuminated surface and the distance between the light source and the illuminated surface, determining the maximum emitted half-angle of the reflector, and determining an aperture of the light entering opening; in a two-dimensional plane, forming multiple line segments by using one end point of the light entering opening as the start point, determining the slope and the end point for each line segment using the reverse tracing method and the iterative method and forming one curved line by the multiple line segments; and rotating the generating line around the axis of the reflector to obtain the reflective curved surface of the inner wall of the reflector.

### TECHNICAL FIELD OF THE INVENTION

The invention relates to a method for designing a reflector, in particular to a method for designing a uniform illumination bunching reflector using an LED light source. The invention is based on Chinese invention patent application No. 201010266973.1, filed on Aug. 30, 2010, the entire content of which is hereby incorporated by reference.

### BACKGROUND OF THE INVENTION

As a new type of illumination light source, LED light sources have the advantages of energy conservation, environmental protection, long service life, low energy consumption, etc. It has been widely applied in many occasions, such as household illumination, commercial illumination, highway illumination, industrial and mine illumination, etc.

An LED light source has an LED chip as the light source, and a reflector is arranged on the LED chip. The structure of the LED chip and the reflector is showed by diagram 1. The reflector 10 has an inner wall 11, the inner surface of which is a smooth curved surface, and the inner surface is the reflection surface of the reflector. The light emitted from the LED chip is reflected by the inner surface and then emitted. The light entering opening 12 of the reflector 10 is located on the upper end of the inner wall 11 and the LED chip 13 is fixed on the inner surface of the light entering opening 12 and is sealed by an encapsulating material 14. A light emitting opening 15 is located on the opposite side of the light entering opening 12 of reflector 10. The light from the LED chip 13 is reflected by the inner surface of the inner wall 11 of the reflector 10 and then emitted from the light emitting opening 15.

Prior reflectors are usually designed by reverse tracing method in which light is taken as a luminous beam and traced reversely from the illuminated surface to the light source. The principle of the reverse tracing method is introduced as follows with reference to FIG. 2 and FIG. 3. As shown in FIG. 2, the light L1 from the light source 21 undergoes a mirror reflection when passing the reflection surface 22 and becomes reflective light L2 which is incident to the illuminated surface 23 to form an image.

Therefore, according to the path reversal principle, if the position of the light on the illuminated surface 23, the position of the light on the reflection surface 22 and the direction of the reflective light are known, the direction of the incident light can be worked out and the direction of the light source 21 can be inferred according to the light reflection principle. This principle is called reverse tracing method.

As shown in FIG. 3, if the position of the light on the illuminated surface 23, the position of the light on the reflection surface 22 and the direction of the reflective light are known, the direction of the light source 21 can be worked out according to the reverse tracing method. In calculation, the illuminated point is taken as a light source, the reflective light is taken as an incident light, and the light source 21 can be known on the straight line that the light L3 lies on by working out the direction of reflective light L3. If a limiting condition is added to the light source 21, such as the straight-line distance between the light source 21 and the reflection surface 22 or the distance between the light source 21 and the illuminated surface 23, the position of the light source 21 can be worked out.

Similarly, if the position of the light source and the illuminated point and the slope of the reflection surface 22 are known, and either the direction of light L1 or the direction of reflective light L2 is known, the direction of the light L1 or the direction of the reflective light L2 and the position of the reflection point can be worked out.

### SUMMARY OF THE INVENTION

Technical problems

Due to reasons such as high contrast with the ambient environment, LED illumination light sources are likely to produce glare when in use. When people use LED illumination light sources normally, light that is within the field of vision and emitted from the LED illumination light sources forms the light with high intensity and high contrast in a partial region, an extreme contrast is formed in time or space, and the eyes are not used to this extreme contrast, so people's visual feeling is affected.

However, the light distribution design of an existing LED reflector 10 is commonly used for focusing, without taking lamination or brightness requirement of the illuminated surface into account. As shown in FIG. 1, the existing reflector 10 does not uniformly emit light to the illuminated surface according to the requirement of the illuminated surface, that is, it does not rationally distribute the light emitted from an LED chip 13 onto a region to be illuminated according to the glare control requirement.

Technical solution

The major purpose of the invention is to provide a method for designing a uniform illumination bunching reflector with good anti-glare effect.

To achieve the above purpose, in the method for designing a uniform illumination bunching reflector provided in the invention, the reflector has a light entering opening and a light emitting opening that is arranged in opposite to the light entering opening, and an LED light source is arranged on the inner side of the light entering opening. The method comprises the steps of: determining the maximum emitted angle of the reflector based on luminance or brightness of an illuminated surface and the distance between the light source and the illuminated surface, and also based on the requirement of an anti-glare design, further determining the maximum emitted half-angle, and determining the diameter of the light entering opening on a plane on which the light source is located; in a two-dimensional plane, forming multiple line segments, which are connected end to end, by using one end point of the light entering opening as the start point, determining the slope and the end point for each line segment using the reverse tracing method and the iterative method based on the luminance requirement for the illuminated surface, and forming one curved line by the multiple line segments; determining the position on the curved line at which an end point of the light emitting opening is located based on the maximum emitted half-angle, and using one segment of the curved line between the end point of the light entering opening and the end point of the light emitting opening as a generating line for the inner wall of the reflector; and rotating the generating line around the axis of the reflector by one turn to obtain the reflective curved surface of the inner wall of the reflector.

One preferred solution is that the light source arranged inside the reflector is a point light source; and the method for calculating the line segment of the generating line is as follows: in a two-dimensional plane, partitioning half of the illuminated surface into a plurality of equal parts, and determining an end point of each equal part; determining the direction of light passing through each end point based on the light intensity distribution on the illuminated surface; forming a first line segment with a certain slope by using the end point of the light entering opening as the start point, so that the light, which is formed after light emitted from the light source is reflected by the midpoint of the first line segment, is the light passing through a certain end point on an illuminated surface; and, repeating the step of calculating the first line segment, and calculating the stop point and slope of the next line segment using the stop point of the last line segment as the start point.

Another preferred solution is that the light source arranged in the reflector is a plane light source; and the method for calculating multiple line segments is as follows: in a two-dimensional plane, forming a first line segment with a certain slope by using the first end point of the light entering opening as the start point, so that the light, which is formed after light emitted from the second end point of the light entering opening is reflected by the midpoint of the first line segment, is the light with the maximum emitted half-angle; and, repeating the step of calculating the first line segment, and calculating the stop point and slope of the next line segment using the stop point of the last line segment as the start point.

Advantages

Compared with the prior art, during the design of the reflector in the invention, the anti-glare requirement of the reflector is taken into account first, and the maximum emitted half-angle of the reflector is determined based on this requirement. During the design of the generating line of the reflector, all emitted angles of the reflective light are smaller than the maximum emitted half-angle, so that it is ensured that the light emitted from the light source will not produce glare after being reflected by the reflector.

### BRIEF DESCRIPTION OF THE DRAWINGS

FIG. 1 is a sectional view of a reflector and an LED chip;

FIG. 2 is a schematic diagram of mirror reflection;

FIG. 3 is a schematic diagram of a reverse tracing method;

FIG. 4 is a diagram of a light source and an illuminated surface in a first embodiment of the invention;

FIG. 5 is a diagram of determining the maximum emitted angle of the reflector in the first embodiment of the invention;

FIG. 6 is a diagram of calculating a generating line of the reflector in the first embodiment of the invention;

FIG. 7 is a diagram of calculating a generating line of the reflector in a second embodiment of the invention; and

FIG. 8 is a structure diagram of a combination of the uniform illumination bunching reflector designed in the second embodiment of the invention with an LED chip and a circuit board.

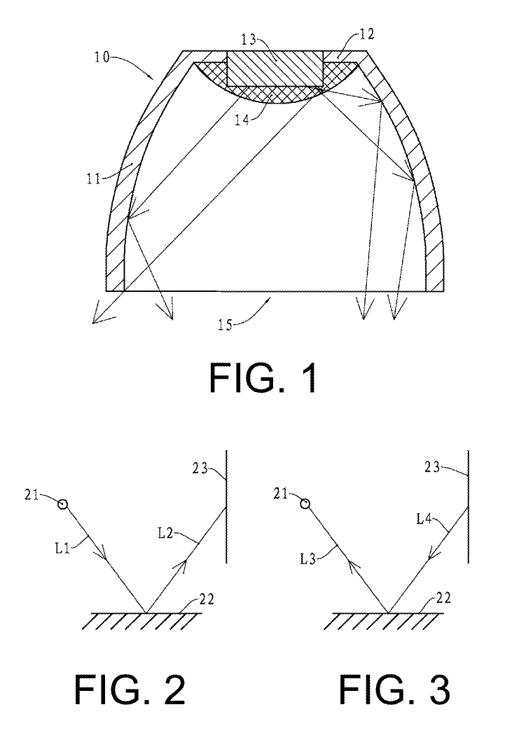

The invention will be further described below with reference to drawings and embodiments.

### DETAILED DESCRIPTION OF THE PREFERRED EMBODIMENTS

The method for designing a uniform illumination bunching reflector in the invention is as follows: in a two-dimensional plane, designing one generating line of the inner surface of the inner wall of the reflector, and then rotating the generating line around the axis of the reflector by one turn to obtain a curved surface of the inner surface of the inner wall of the reflector, namely a reflective curved surface of the reflector. Therefore, the method for designing a generating line described hereinafter is implemented in a two-dimensional plane.

### First Embodiment

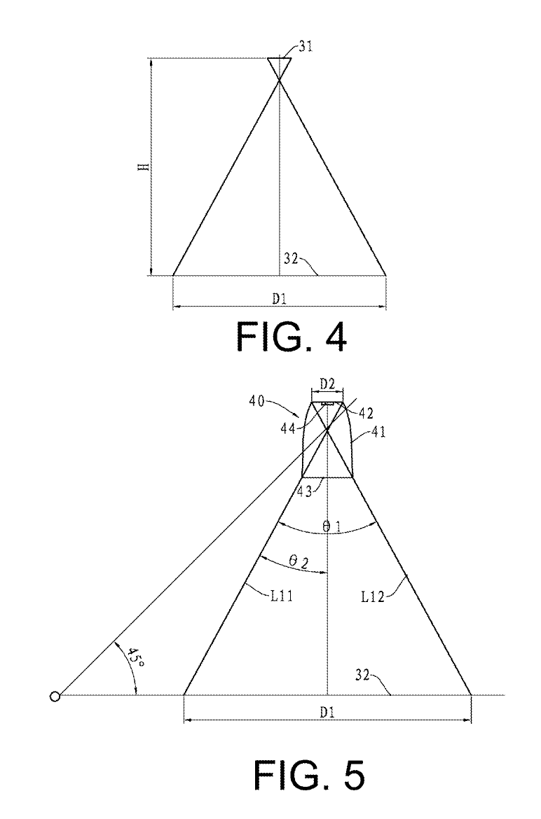

When a reflector is designed, first, it needs to determine the position of the light source, the illuminated area, and the distance between the light source and an illuminated surface and the like based on the application environment of the LED illumination light source. Referring to FIG. 4, the light source in this embodiment is a plane light source that is arranged on a plane 31, the plane 31 is also one on which the light entering opening of the reflector is located, and the plane 31 is arranged in parallel with an illuminated surface 32. The illuminated surface 32 is located right beneath the light source and has a diameter of D1, and the distance between the illuminated surface 32 and the light source is H.

Then, the maximum emitted angle of the reflective light that is formed after light is reflected by the reflector is determined. In order to control glare, when the maximum emitted angle of the light emitted from the reflector, the angle of the production of glare must be taken into account. As shown in FIG. 5, in a case of eye level view, the view angle range with glare forms an included angle of 45° with the horizontal line, therefore, as long as the light being emitted from the light source 44 and forming an included angle larger than 45° with the horizontal line is reflected by the reflector, the light emitted from the LED light source will not be emitted to eyes directly, thus avoiding the production of glare.

It is assumed that the reflector 40 in FIG. 5 is an already-designed reflector, the reflector has an inner wall 41 serving as a reflection surface, the upper end of the inner wall 41 is the light entering opening of the reflector 40, the light source 44 is located in the center of the light entering opening, that is, the light source is arranged on the inner side of the light entering opening 42, what is opposite to the light entering opening 42 is the light emitting opening 43 of the reflector 40, part of line emitted from the light source 44 is reflected by the inner wall 41 and then emitted from the light emitting opening 43 of the reflector 40.

According to the edge ray theory, the maximum emitted angle θ1 of the reflector 40 should be an included angle, which is formed by light L12 connecting the left edge of the light entering opening 42 of the reflector with the right edge of the illuminated surface 32 and light L11 connecting the right edge of the light entering opening 42 of the reflector with the left edge of the illuminated surface 32, and, half of the maximum emitted angle θ1, namely an included angle θ2 formed by the light L11 and the axis of the reflector, is the maximum emitted half-angle. It can be found from FIG. 5 that, when the maximum emitted half-angle θ2 is smaller than 45°, glare can be controlled effectively. According to the above method, both the maximum emitted angle θ1 and the maximum emitted half-angle θ2 of the reflector 40 can be determined.

Furthermore, according to the practical use of the LED illumination light source, the diameter of the light entering opening 42 of the reflector can be determined. As shown in FIG. 5, the diameter of the light entering opening 42 of the reflector is D2.

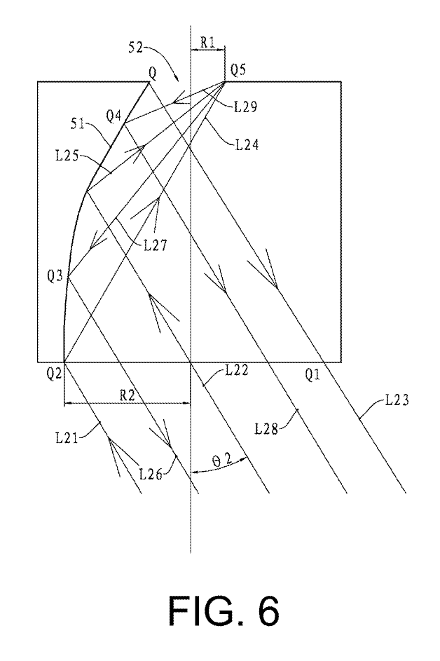

The plane light source may be considered as a light source formed of numerous of point light sources. In a reflector device model as shown in FIG. 6, when parallel light L21 and light L22 are incident to the boundary 51 of the reflector device in the maximum emitted half-angle θ2, all reflective light L24 and reflective light L25 pass through the edge of the light entering opening 52 of the reflector device, namely point Q5.

When the incident angle of both the incident light L21 and the incident light L22 decreases, the reflective light L24 and the reflective light L25 will be incident into the light entering opening 52 of the reflector device.

Therefore, according to the path reversal principle, light emitted from the light source in an angle larger than the emitted angle will be emitted out in an angle smaller than the emitted angle.

When the generating line of the reflector is designed, first, in a two-dimensional plane, a first line segment with a certain slope is formed by using one end point of the light emitting opening of the reflector, namely point Q, so that the light L28, which is formed after light L29 emitted from another end point Q5 of the light entering opening is reflected by the midpoint of the first line segment, namely point Q4, is the light with the maximum emitted half-angle.

Then, a second line segment with a certain slope is formed by using the stop point of the first line segment as the start point, so that the light L26, which is formed after light L27 emitted from the end point Q5 is reflected by the midpoint Q3 of said second line segment, is also the light with the maximum emitted half-angle. By the above steps, the end point and slope of each line segment are determined by using the stop point of the last line segment as the start point of the next line segment and using the reverse tracing method, and multiple line segments are calculated using the iterative method. These line segments, which are connected end to end, form one curved line.

Multiple line segments are calculated repeatedly using the above method, until such one line segment is obtained: the light L24 emitted from the end point Q5 to the midpoint Q2 of said line segment is the light with the maximum emitted half-angle, so the midpoint Q2 of said line segment is one end point of the light emitting opening of the reflector, namely the lower end point of the generating line of the reflection surface of the reflector. Therefore, the point Q2 may be considered as the intersection point of the light L24 with the maximum emitted half-angle that is formed through the point Q5 and the curved line.

Then, the curved line between the end point Q of the light entering opening of the reflector and the end point Q2 of the light emitting opening is used as one generating line of the reflection surface of the reflector. It can be found that, when many line segments, for example thousands of line segments, are selected, the calculated generating line is almost a smooth arc line.

After the above steps, the generating line of the reflection surface of the reflector is well designed, and the generating line is rotated around the axis of the reflector to obtain the reflective curved surface of the inner wall of the reflector.

Thus it can be seen that, when the generating line of the reflector is designed, given the purpose of anti-glare, the maximum emitted angle is designed based on the requirement of anti-glare, the light which is formed after the light emitted from the LED light source is reflected by the reflector will not be emitted in an angle larger than the maximum emitted angle, so the production of glare is avoided effectively.

### Second Embodiment

In this embodiment, the light source is a point light source that has the Lambert property.

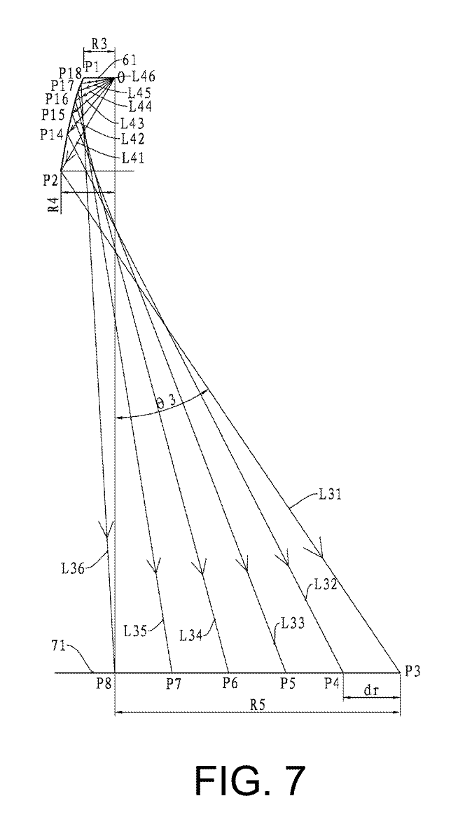

When the reflector is designed, similar to the first embodiment, first, one generating line of the inner surface of the reflector is designed, and then the generating line is rotated around the axis of the reflector to obtain the curved surface of the inner surface of the inner wall of the reflector. Before the design of the generating line, it needs to determine parameters of the reflector according to the practical application environment. As shown in FIG. 7, the point light source is arranged at the point O, the radius of the light entering opening 61 of the reflector is R3, and the radius of the illuminated surface 71 is R5. Meanwhile, the angle of anti-glare is determined according to the method mentioned in the first embodiment, that is, the maximum emitted half-angle of the light emitted from the reflector is determined, namely θ3 as shown in FIG. 7.

Then, half of the illuminated surface 71 is partitioned into five equal parts, each of which has a length of dr, the end point P3, P4, P5, P6, P7, P8 of each equal part is determined, the direction of the reflective light L32, L33, L34, L35, L36 passing through each end point P4, P5, P6, P7, P8 is determined based on the light intensity distribution on the illuminated surface, and, the included angle between each reflective light L32, L33, L34, L35, L36 and the illuminated surface 71 increases in turn, that is, the emitted angle of the reflective light decreases in turn. Meanwhile, the light L31 passing through the end point P3 of the illuminated surface should be the light with the maximum emitted half-angle.

Then, a first line segment with a certain slope is formed by using one end point P1 of the light entering opening 61 as the start point, so that the light, which is formed after light L46 emitted from the light source O is reflected by the midpoint P18 of the first line segment, is the light L36 passing through one end point P8. In this way, the two end points and slope of the first line segment can be determined.

Then, a second line segment is formed by using the stop point of the first line segment as the start point, so that the line L35, which is formed after light L45 emitted from the light source O is reflected by the midpoint P17 of the second line segment, is the light passing through the end point P7.

By the above method, new line segments are calculated continuously, and these line segments, which are connected end to end, form one curved line.

The above method is used until such one line segment is obtained: the light L31, which is formed after the light L41 emitted from the light source O is reflected by the midpoint P2 of said line segment, is the light with the maximum emitted half-angle. So the midpoint P2 of said line segment is the end point of the light emitting opening of the reflector. It can be found that, the end point P2 of the light emitting opening may be considered as the intersection point of the light L31 with the maximum emitted half-angle that is formed through the end point P3 of the illuminated surface and the curved line that is formed of multiple line segments.

Then, a segment of the curved line between the end point P1 of the light entering opening and the end point P2 of the light emitting opening is used as the generating line of the inner surface of the reflector. It can be found that, the slope of the line segments forming the generating line gradually decreases from the end point P1 of the light entering opening to the end point P2 of the light emitting opening, and, the point P2 is also the intersection point of the generating line and the maximum emitted angle of the reflector.

After the above calculation, one generating line of the reflector may be determined, and the generating line is rotated around the axis of the reflector to obtain the reflective curved surface of the inner wall of the reflector.

As the problem of glare is taken into account when the generating line of the reflector is designed, all angles of the light emitted from the reflector are smaller than the maximum emitted half-angle, thus the production of glare may be avoided effectively.

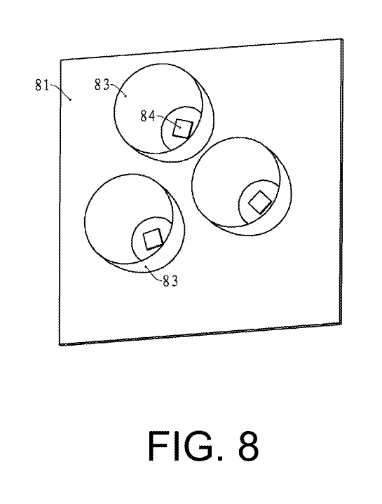

The LED illumination light source applying said reflector may be a single-channel and multi-channel light source. As shown in FIG. 8, the LED light source has a substrate 81, a plurality of LED chips 84 are arranged on the substrate 81, and each LED chip 84 is externally provided with a reflector 83 designed according to the above method. As the LED illumination light source is provided with a plurality of reflectors 83, the light beams of the plurality of reflectors 83 are bunched to form the spot of the LED light source. Therefore, the LED illumination light source is one having multi-channel uniform illumination bunching reflectors.

Finally, it should be emphasized that the invention is not limited to the above implementation ways. For example, the change of the number of the reflection points, the change of the maximum emitted angle, and the change of the number of the reflectors should also fall within the protection scope defined by the claims of the invention.

### INDUSTRIAL APPLICABILITY

Compared with the prior art, during the design of the reflector in the invention, the anti-glare requirement of the reflector is taken into account first, and the maximum emitted half-angle of the reflector is determined based on this requirement. During the design of the generating line of the reflector, all emitted angles of the reflective light are smaller than the maximum emitted half-angle, so that it is ensured that the light emitted from the light source will not produce glare after being reflected by the reflector. Therefore, the uniform illumination bunching reflector designed according to the invention has good anti-glare effect.

1. A method for designing a uniform illumination bunching reflector, one end of which is provided with a light entering opening and the other end of which is provided with a light emitting opening that is arranged in opposite to the light entering opening, a light source being arranged on the inner side of the light entering opening, wherein the method comprises the steps of:
determining the maximum emitted angle based on the luminance or brightness requirement of an illuminated surface and the distance between the light source and the illuminated surface, and also based on the requirement of anti-glare design, further determining the maximum emitted half-angle, and determining the diameter of the light entering opening on a plane on which the light source is located;
in a two-dimensional plane, forming multiple line segments, which are connected end to end, by using one end point (P1, Q) of the light entering opening as the start point, determining the slope and the end point for each line segment using the reverse tracing method and the iterative method based on the luminance requirement for the illuminated surface, and forming one curved line by the multiple line segments;
determining the position on the curved line at which an end point of the light emitting opening is located based on the maximum emitted half-angle, and using one segment of the curved line between the end point of the light entering opening and the end point of the light emitting opening as a generating line for the inner wall of the reflector; and
rotating the generating line around the axis of the reflector by one turn to obtain the reflective curved surface of the inner wall of the reflector.

2. The method for designing a uniform illumination bunching reflector of claim 1,
wherein,
the light source is a point light source;
the method for calculating the line segment is as follows:
in a two-dimensional plane, partitioning half of the illuminated surface into a plurality of parts, and determining an end point (P3, P4, P5, P6, P7, P8) of each part;
determining the direction of light (L32, L33, L34, L35, L36) passing through each said end point (P3, P4, P5, P6, P7, P8) based on the light intensity distribution on the illuminated surface;
forming a first line segment with a certain slope by using the end point (P1) of the light entering opening as the start point, so that the light, which is formed after light (L46) emitted from the light source is reflected by the midpoint (P18) of the first line segment, is the light (L36) passing through the end point (P8); and
repeating the step of calculating the first line segment, and calculating the stop point and slope of the next line segment using the stop point of the last line segment as the start point.

3. The method for designing a uniform illumination bunching reflector of claim 2,
wherein, the method for determining the end point (P2) of the light emitting opening is as follows:
in a two-dimensional plane, forming light (L31) with the maximum emitted half-angle from the end point (P3) of the illuminated surface, and using the intersection point of the light (L31) with the maximum emitted half-angle and the curved line as the end point (P2) of the light emitting opening.

4. The method for designing a uniform illumination bunching reflector of claim 1,
wherein,
the light source is a plane light source;
the method for calculating the line segment is as follows:
in a two-dimensional plane, forming a first line segment with a certain slope by using the first end point (Q) of the light entering opening as the start point, so that the light (L28), which is formed after light emitted from the second end point (Q5) of the light entering opening is reflected by the midpoint (Q4) of the first line segment, is the light with the maximum emitted half-angle; and repeating the step of calculating the first line segment, and calculating the stop point and slope of the next line segment using the stop point of the last line segment as the start point.

5. The method for designing a uniform illumination bunching reflector of claim 4,
wherein, the method for determining the end point (Q2) of the light emitting opening is as follows:
in a two-dimensional plane, forming light (L24) with the maximum emitted half-angle through the second end point (Q5) of the light entering opening, and using the intersection point of the light (L24) with the maximum emitted half-angle and the curved line as the end point (Q2) of the light emitting opening of the reflector.

6. The method for designing a uniform illumination bunching reflector according to any one of claim 1,
wherein, the slope of the multiple line segments in turn changes in a single direction from the light entering opening of the reflector to the light emitting opening of the reflector.

7. The method for designing a uniform illumination bunching reflector according to any one of claim 2,
wherein, the slope of the multiple line segments in turn changes in a single direction from the light entering opening of the reflector to the light emitting opening of the reflector.

8. The method for designing a uniform illumination bunching reflector according to any one of claim 3,
wherein, the slope of the multiple line segments in turn changes in a single direction from the light entering opening of the reflector to the light emitting opening of the reflector.

9. The method for designing a uniform illumination bunching reflector according to any one of claim 4,
wherein, the slope of the multiple line segments in turn changes in a single direction from the light entering opening of the reflector to the light emitting opening of the reflector.

10. The method for designing a uniform illumination bunching reflector according to any one of claim 5,
wherein, the slope of the multiple line segments in turn changes in a single direction from the light entering opening of the reflector to the light emitting opening of the reflector.
